(19) United States
(12) Patent Application Publication
(10) Pub. No.: US 2025/0289297 A1
(43) Pub. Date: Sep. 18, 2025

(54) AUTOMOTIVE DOOR REINFORCEMENT AND NOISE REDUCTION

(71) Applicant: FCA US LLC, Auburn Hills, MI (US)

(72) Inventors: Peng Feng, Foshan City (CN); Chunmei Fan, Shanghai (CN); Fanhui Zhang, Shanghai (CN)

(21) Appl. No.: 18/606,167

(22) Filed: Mar. 15, 2024

(51) Int. Cl. B60J 5/04

(52) U.S. Cl. CPC B60J 5/0418; B60J 5/042

(57) ABSTRACT

An automotive door includes a door frame, a door panel coupled to the door frame comprising a reinforcement zone and a reinforcement member disposed at the reinforcement zone composed of solidified glue.

### FIELD

The present disclosure relates to a method and system for reinforcing a door and reducing resonance of the door panel.

### BACKGROUND

This section provides background information related to the present disclosure which is not necessarily prior art.

To reduce weight in a vehicle, door panels or skins have the thickness reduced. Reducing the thickness of the door skin reduces the weight but also reduces the strength of the door skin. A reduced thickness door skin may also resonate and generate noise within the passenger compartment. Tape has been used to reinforce the door and reduce the resonance noise therefrom. However, applying tape requires further operation in the manufacturing environment. Reducing the manufacturing time is desirable.

### SUMMARY

This section provides a general summary of the disclosure and is not a comprehensive disclosure of its full scope or all of its features.

The present disclosure provides projection glue to the inside of a door panel to reinforce the door panel and reduce the resonance noise therefrom.

In one aspect of the disclosure, an automotive door includes a door frame, a door panel coupled to the door frame comprising a reinforcement zone and a reinforcement member disposed at the reinforcement zone composed of solidified glue.

In another aspect of the disclosure, a method includes determining a reinforcement zone for a door panel, heating glue, applying the glue on an inside of the door panel and cooling the glue in the reinforcement zone to form solidified glue and form a reinforcement member the door panel.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a perspective view of a vehicle having a reinforced door according to the present disclosure.

FIG. 2 is an inside view of a door having the internal door panel removed.

FIG. 3A is an exterior view of the door panel having the reinforcement portion therein.

FIG. 3B is an inside view with the inner panel removed showing the reinforcement portions therein.

FIG. 4 is a perspective view of a projection gluing apparatus.

FIG. 5 is a flowchart of a method for forming the reinforcement member and frequency attenuator.

Corresponding reference numerals indicate corresponding parts throughout the several views of the drawings.

### DETAILED DESCRIPTION

Example embodiments will now be described more fully with reference to the accompanying drawings.

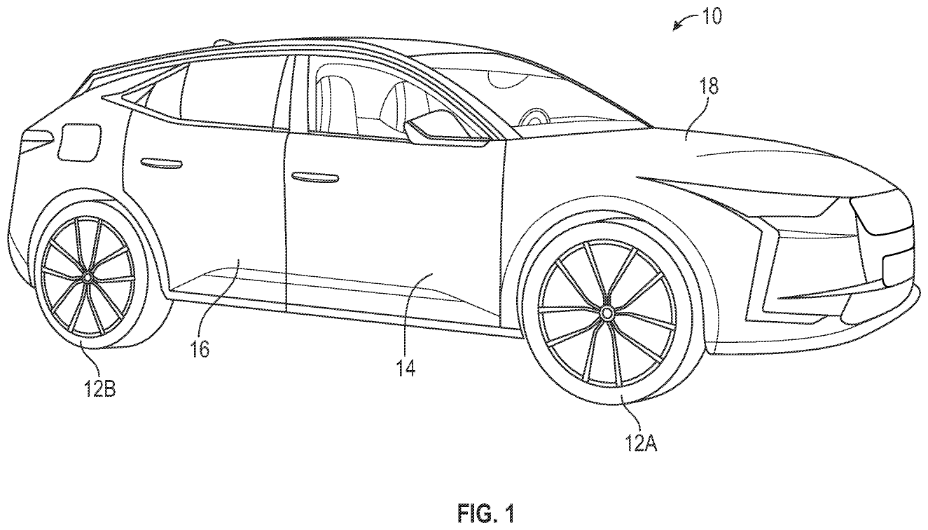

Referring now to FIG. 1, a perspective view of an automatic vehicle 10 is set forth. The automotive vehicle 10 has front wheels 12A and rear wheels 12B, only one of each is illustrated. The vehicle 10 has a pair of front doors 14 and a pair of rear doors 16 that are coupled to the vehicle body 18. The following description is provided for a rear door 16. However, the teachings set forth herein may be applied to the front doors 14 as well.

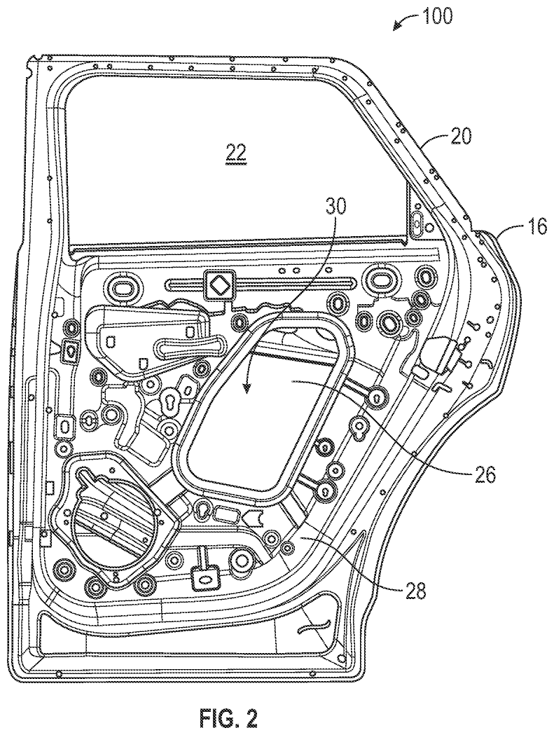

Referring now to FIG. 2, an assembly 100 forming the rear door 16 is set forth. The rear door 16 has a door frame 20 that surrounds a window area 22. The assembly 100 forming the rear door 16 includes an outer door panel 26 which may be referred to as a door skin. The outer door panel 26 forms the finished surface on the outside of the vehicle as illustrated in FIG. 1. The outer door panel 26 is coupled to the door frame 20 by welding, gluing or the like. The finished trim is coupled to the outer door panel 26.

An inner door panel 28 is coupled to the door frame 20. Typically, the outer door panel 26 and inner door panel 28 are formed of the same material. Typically, steel or aluminum are used. A hollow space or cavity 30 is disposed between the outer door panel 26 and the inner door panel 28. The shape and size of the cavity 30 may lead to resonance that is heard within the vehicle. Likewise, the outer door panel 26 may be formed of a thin material which requires localized strengthening to meet motor vehicle standards.

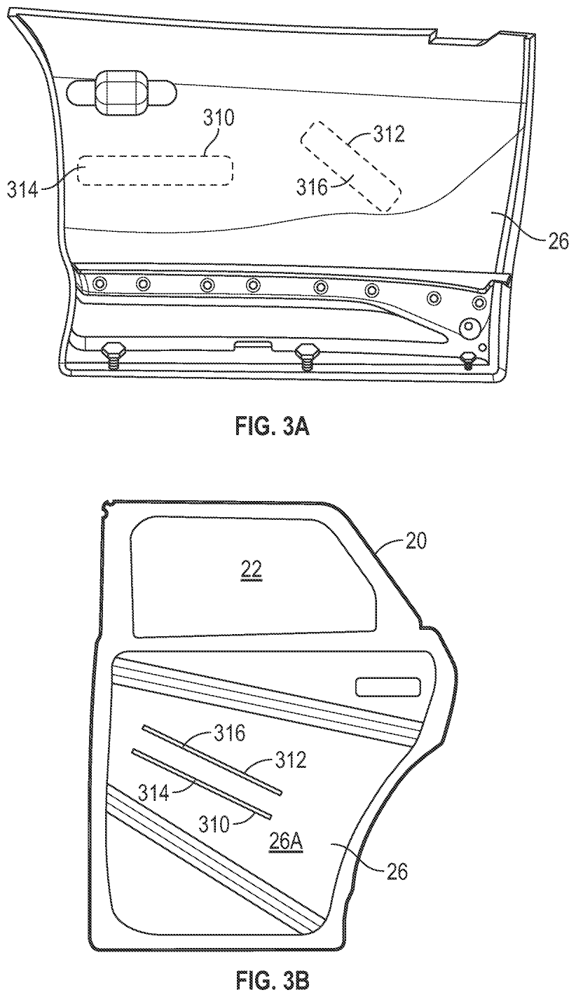

Referring now to FIG. 3A, an outside view of an outer door panel 26 is set forth. The outer panel 26 has a first zone 310 and a second zone 312. The zones 310, 312 may be referred to as a reinforcement zone as a glue as applied to the inside surface 26A of the outer door panel 26 to reinforce the outer door panel 26. The reinforcement zones 310, 312 have a reinforcement members 314, 316, respectively. The reinforcement members 314, 316 are formed by the solidifying glue as applied to the inside of the door surface as described in greater detail below.

In FIG. 3B, the inside surface 26A of the outer door panel 26 is illustrated with the inner door panel 28 removed. The reinforcement zones 310, 312 are illustrated where the glue forms reinforcement members 314, 316 for reinforcing the inner surfaces 26A and for forming a resonance frequency attenuator. In FIG. 3B the reinforcement zones 310, 312 and reinforcement members 314, 316 are illustrated in different positions than FIG. 3A to illustrate that various locations may be used depending on the door design.

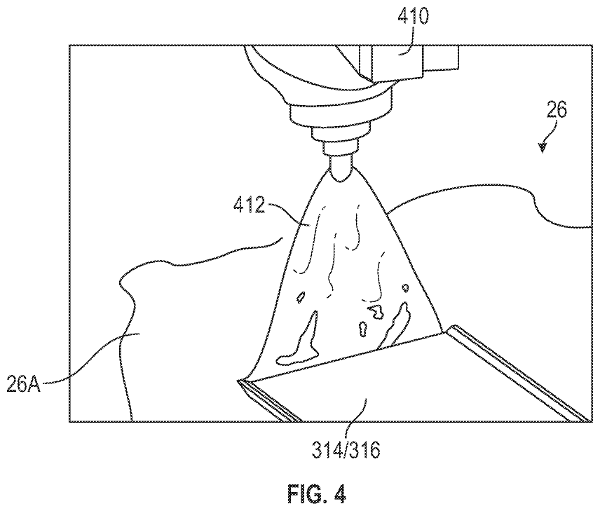

Referring now to FIG. 4, a projection gluing machine 410 is set forth. The projection gluing machine 410 is shown spraying or projecting heated glue 412 onto the inside surface 26A of the outer door panel 26. The width and the position of the reinforcement zone 310, 312 and therefore the reinforcement member 314, 316 are determined during testing. Once the heated glue cools, solidified glue forms the reinforcement members 314, 316. Projection gluing machines may be present to glue door panels to the frames so including an extra operation without new equipment is a cost saving.

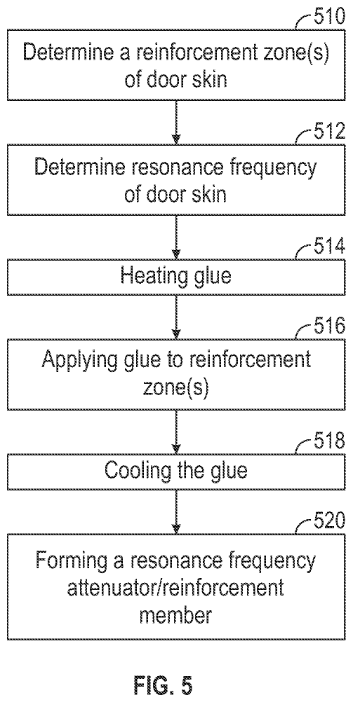

Referring now to FIG. 5, a method of forming a reinforcement for a door panel is set forth. In step 510, a reinforcement zone or zones of a door panel are identified. The reinforcement zones may be identified using various testing methods. The reinforcement zones may be used to strengthen the door panel in an identified area. Because of the shape, thickness and other components within the vehicle, impact testing or simulated testing may be used to determine the desired location for the reinforcement zone. Likewise, the reinforcement member formed at the reinforcement zone may be used to reduce or attenuate the resonance frequency emanating from the hollow space or cavity 30 between the outer door panel 26 and the inner door panel 28. Physical testing or computer simulated testing may be used in this manner. The resonance frequency is therefore determined in step 512.

As mentioned above, a reinforcement member or members 314, 316 may be formed from an adhesive or glue material that is solidified in place. The glue is heated to be applied in step 514. In step 516, the glue is applied to the identified reinforcement zone or zones by projection gluing. Projection gluing in step 516 projection sprays the glue onto the reinforcement zones. In one example, the glue is applied in one pass at the desired reinforcement zone.

In step 518, the applied glue is cooled at the reinforcement zone to form solidified glue.

In step 520, a resonance frequency attenuator and/or reinforcement member is formed. The formed member may provide both reinforcement and frequency attenuation to reduce noise emanating from the door and strengthen the outer door panel.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An automotive door comprising;
a door frame;
a door panel coupled to the door frame comprising a reinforcement zone; and
a reinforcement member disposed at the reinforcement zone composed of solidified glue.

2. The automotive door of claim 1 wherein the reinforcement member is a frequency attenuator.

3. The automotive door of claim 1 further comprising an inner door panel coupled to and spaced apart from the inner door panel to form a cavity therebetween.

4. The automotive door of claim 3 wherein the reinforcement member is a frequency attenuator attenuating a resonance frequency with the cavity.

5. The automotive door of claim 1 wherein the reinforcement zone comprises a first reinforcement zone and a second reinforcement zone and the reinforcement member comprises a first reinforcement member and a second reinforcement member.

6. The automotive door of claim 5 wherein the first reinforcement member is a first frequency attenuator and the second reinforcement member is a second frequency attenuator.

7. An automotive vehicle comprising:
a vehicle body;
a first door comprising the automotive door of claim 1.

8. The automotive door of claim 1 further comprising a second door comprising the door of claim 1.

9. A method comprising:
determining a reinforcement zone for a door panel;
heating glue;
applying the glue on an inside of the door panel; and
cooling the glue in the reinforcement zone to form a reinforcement member of the door panel.

10. The method of claim 9 further comprising determining a resonance frequency of the door panel.

11. The method of claim 10 further comprising determining the reinforcement zone to reduce the resonance frequency.

12. The method of claim 9 wherein cooling the glue comprises forming a resonance frequency attenuator.

13. The method of claim 9 wherein applying glue comprises projection spraying glue on the reinforcement zone.

14. The method of claim 9 wherein determining the reinforcement zone comprises determining a first reinforcement zone and a second reinforcement zone of the door panel.

15. The method of claim 14 further comprising applying glue to the first reinforcement zone and the second reinforcement zone.
